(19) United States
(12) Patent Application Publication
(10) Pub. No.: US 2006/0069764 A1
(43) Pub. Date: Mar. 30, 2006

(54) Computer switching device

(75) Inventors: Tatsumi Azuma, Tokyo (JP); Nobuyuki Abe, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/210,660

(22) Filed: Aug. 25, 2005

(30) Foreign Application Priority Data
Sep. 10, 2004 (JP) 2004-263726

(51) Int. Cl. G06F 15/173

(52) U.S. Cl. 709/223

(57) ABSTRACT

The present invention is aimed at achieving a computer switching device for switching between a plurality of computers for the operation using common user interfaces. The computer switching device comprises an input device switcher for performing switching to a computer to be controlled by input user interfaces, an image processor for processing images from computers, a communication interface for performing data communications with computers, and a user interface controller for controlling the input device switcher and the image processor based on information from the communication interface. The employment of these components enables construction of a computer switching device by which a computer to be controlled by one set of user interfaces can be switched effortlessly and screens from the controllable and uncontrollable computers connected to the computer switching device ones can be simultaneously displayed on one monitor.

### BACKGROUND OF INVENTION

1. Field of the Invention

The present invention relates to a computer switching device disposed in between a plurality of computers and user interfaces, namely, a monitor, a keyboard, and a mouse, in order to enable the operation of the plurality of computers via the common user interfaces.

2. Description of the Prior Art

Conventionally, there is a system where one set of user interfaces, namely, a monitor, a keyboard, and a mouse, are connected to a plurality of computers via a computer switching device. Such a system is aimed at saving on space and costs.

FIG. 1 is a block diagram of a conventional computer switching device employed in the aforementioned conventional system.

In FIG. 1, computer switching device 10 is disposed in between user interface 4, comprised of one set of keyboard 1, mouse 2, and monitor 3, and a plurality of computers 5a, 5b, and 5c. Keyboard 1, mouse 2, and monitor 3 are switched by keyboard switcher 11, mouse switcher 12, and monitor switcher 13, respectively, to the appropriate one of the plurality of computers 5a, 5b, and 5c.

In one conventional computer switching system, a switching device is equipped with a switch, by which the user manually selects a computer to be controlled by user interfaces.

In another conventional system, when the computer is informed that the mouse-controlled cursor has moved out of bounds of the screen displayed on the monitor, the computer refers to the computer connection definition table, according to which computers are switched.

A multi-computer system in which a controllable computer and data therefrom displayed on the monitor are switched based on the cursor information is described in the following patent literature:

(Patent Document 1)

Gazette for Japanese Laid-open Patent Application No. 2002-323968

However, conventional systems have the following problems:

The selection of a computer to be controlled by one set of user interfaces, namely, a monitor, a keyboard, and a mouse, requires manual control of the switch, which is inefficient.

In conventional switching methods using a manually-controlled switch and cursor, the monitor only displays data from the selected computer, but data from other computers connected to the switching device cannot be simultaneously seen on the same monitor. This shortcoming is not problematic when different computers are performing unrelated tasks. When tasks relate to each other however, not being able to simultaneously see data from different computers on one monitor is inconvenient.

There is software for outputting data stored in another computer and displaying the same on the monitor via the network. Such software could adversely affect the performance of the computer whose screen is displayed on the monitor as a main screen. The software itself could also hinder the performance of the computer depending on the reliability of the software.

### SUMMARY OF INVENTION

The present invention is aimed at solving the aforementioned problems. It is specifically aimed at achieving a computer switching device for facilitating switching between computers connected to one set of user interfaces and for enabling screens from the controllable computer and uncontrollable ones to be simultaneously displayed on one monitor.

### BRIEF DESCRIPTION OF DRAWINGS

FIG. 1 is a block diagram of a conventional computer switching device.

FIG. 2 is a block diagram of an example embodiment of the present invention.

FIG. 3 is a schematic diagram of example screens on the monitor in a system employing the present invention.

FIG. 4 is a schematic diagram of another example screen on the monitor in a system employing the present invention.

FIG. 5 is a schematic diagram of another example screen on the monitor in a system employing the present invention.

FIG. 6 is a schematic diagram of an example sub-screen on the monitor in a system employing the present invention.

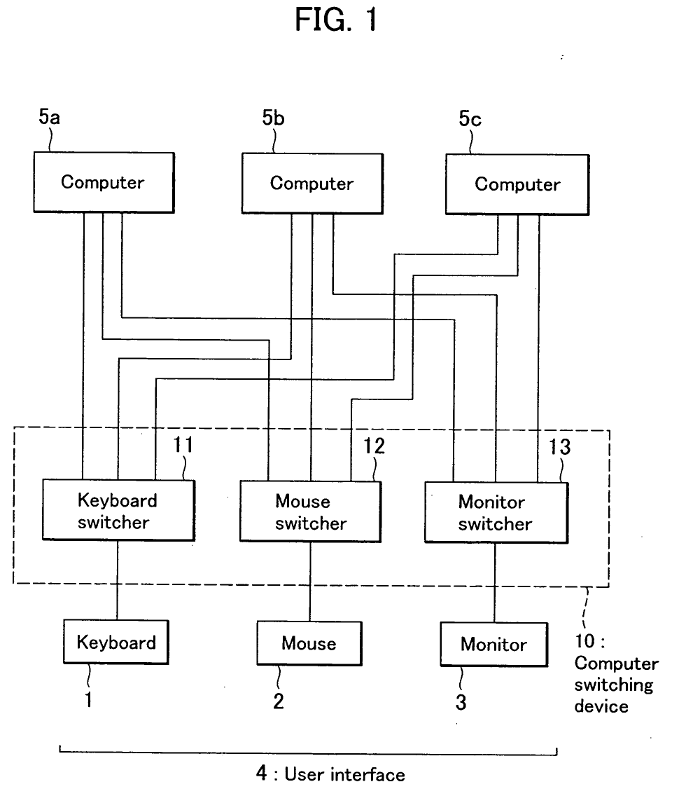

### DESCRIPTION OF THE PREFERRED EMBODIMENTS

The present invention is detailed below using the accompanying drawings.

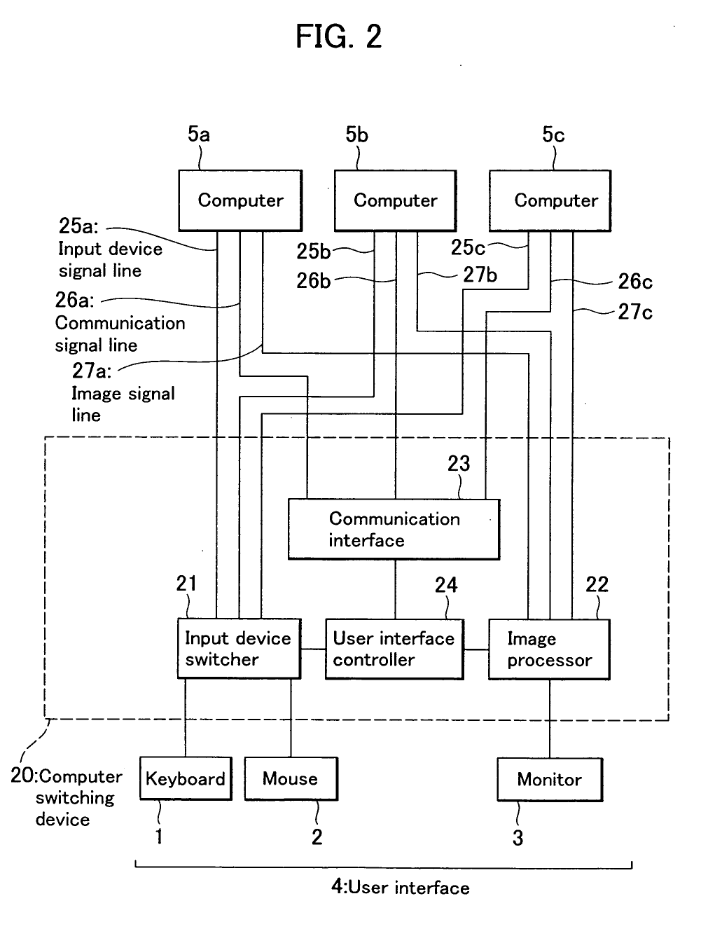

FIG. 2 is a block diagram of an example embodiment of the present invention. Items that have already appeared in a previous figure are denoted by the same notations in subsequent figures.

In FIG. 2, computer switching device 20 is disposed in between user interface 4, comprised of one set of keyboard 1, mouse 2, and monitor 3, and a plurality of computers 5a, 5b, and 5c. In this figure, the number of computers is three, but it does not necessarily have to be three.

Computer switching device 20 comprises input device switcher 21 for performing switching for keyboard 1 and mouse 2, image processor 22 for switching and integrating images from computers, communication interface 23 for performing communications with computers, and user interface controller 24 for controlling input device switcher 21 and image processor 22 according to information from communication interface 23.

Keyboard 1 and mouse 2 are connected via input device switcher 21 to input device signal lines 25a, 25b, and 25c for the plurality of computers 5a, 5b, and 5c, respectively. The plurality of computers 5a, 5b, and 5c are connected via communication signal lines 26a, 26b, and 26c, respectively, to communication interface 23. From the computer controlled by keyboard 1 and mouse 2 via input device switcher 21, coordinate information on a mouse-controlled cursor is transmitted as a communication signal to communication interface 23. The coordinate information on the cursor referred to here is an absolute coordinate value indicating the location of the cursor on the screen on the monitor.

Communication interface 23 forwards the cursor information transmitted from the computer to user interface controller 24.

According to the cursor information forwarded from communication interface 23, user interface controller 24 recognizes the cursor location on a screen integrated by image processor 22 and controls input device switcher 21. Then the computer whose screen with a cursor is made controllable by keyboard 1 and mouse 2. In this way, switching between computers can be performed by simple mouse operation, so that a plurality of computers can be operated as if using one computer on one screen.

Monitor 3 is connected via image processor 22 to image signal lines 27a, 27b, and 27c for the plurality of computers 5a, 5b, and 5c, respectively.

According to image signals from the plurality of computers 5a, 5b, and 5c, user interface controller 24 performs screen switching and integration and the like. The screens of the computers not controllable by user interface 4 can be simultaneously displayed on the same monitor 3. Since tasks being performed by each computer can be seen, work efficiency can be improved.

Windows of different applications are conventionally opened to execute different processes concurrently on one computer. In a computer switching system employing the present invention, for instance, different processes can be assigned to different computers, the windows of which can be simultaneously seen on one monitor.

The employment of computer switching device 20 for screen integration allows for the operation and monitoring of a plurality of computers by one set of user interfaces without imposing a burden on the computer whose screen is displayed as the main screen on the monitor.

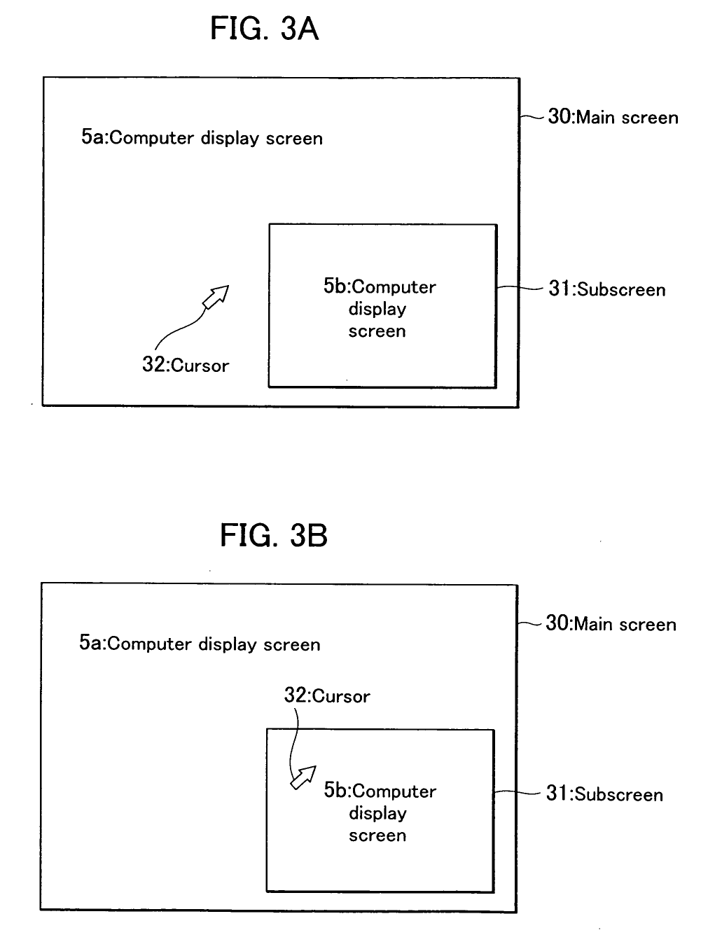

FIG. 3 is a schematic diagram of example screens on the monitor in a system employing the present invention.

FIG. 3 integrates screens of two computers: a main screen and sub-screen. The screen from computer 5a in FIG. 2 is displayed as main screen 30, and that of computer 5b as sub-screen 31. FIG. 3 (a) is a screen where cursor 32 controlled by the mouse is on main screen 30, and FIG. 3 (b) is a screen where cursor 32 is on sub-screen 31.

When cursor 32 is on main screen 30, computer 5a can be controlled by keyboard 1 and mouse 2.

In this setting, switching to computer 5b, whose screen is displayed as sub-screen 31, can be achieved by moving cursor 32 to the area of sub-screen 31. The coordinate information on cursor 32 is in turn transmitted from the controllable computer as a communication signal to communication interface 23. According to the coordinate information on the area of sub-screen 31 and that on cursor 32 from communication interface 23, user interface controller 24 recognizes that cursor 32 is within the bounds of the area of sub-screen 31 and switches input device switcher 21 to computer 5b, whose screen is displayed as sub-screen 31.

Switching to computer 5a, whose screen is displayed as main screen 30, can be achieved by moving cursor 32 out of the bounds of sub-screen 31 to the area of main screen 30. According to the coordinate information on the area of sub-screen 31 and that on cursor 32 from communication interface 23, user interface controller 24 recognizes that cursor 32 has moved out of the bounds of the area of sub-screen 31 and switches input device switcher 21 to computer 5a, whose screen is displayed as main screen 30.

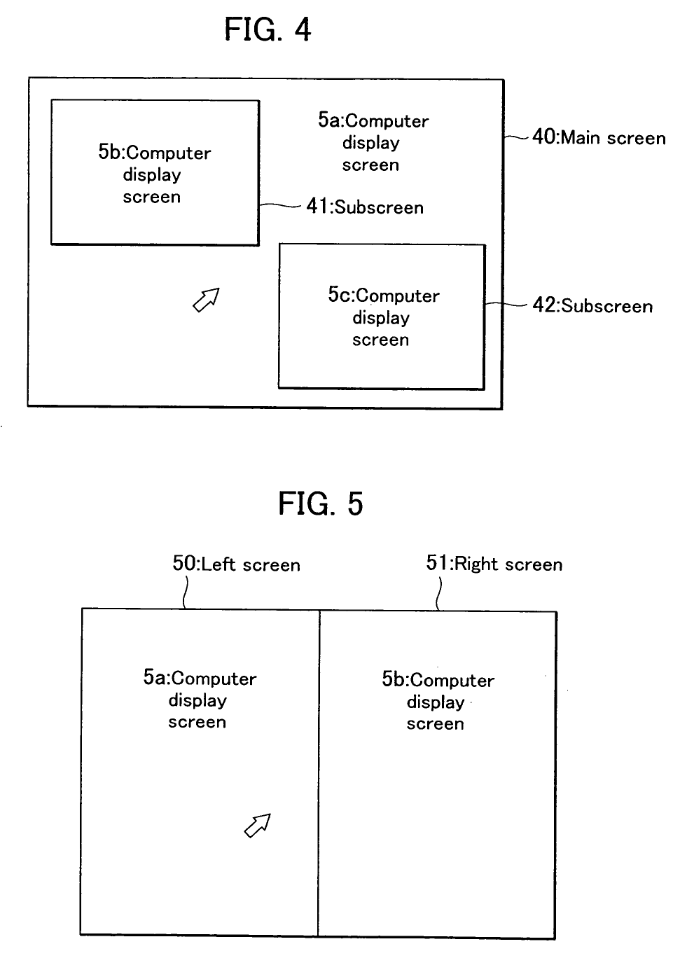

FIG. 4 and FIG. 5 are schematic diagrams of other example screens in a system employing the present invention.

In FIG. 4, the screen from computer 5a in FIG. 2 is displayed as main screen 40, and the screens of computers 5b and 5c are displayed as sub-screens 41 and 42, respectively.

FIG. 5 integrates the screens of computers 5s and 5b in a different fashion, not as a main screen and a sub-screen, but as left screen 50 and right screen 51, respectively.

The screen displayed on the monitor is controlled by user interface controller 24 via image processor 22. The screen can be set up in various ways other than those presented above. For example, the screen can be divided into top and bottom halves, and the number of screens on the monitor can be fixed.

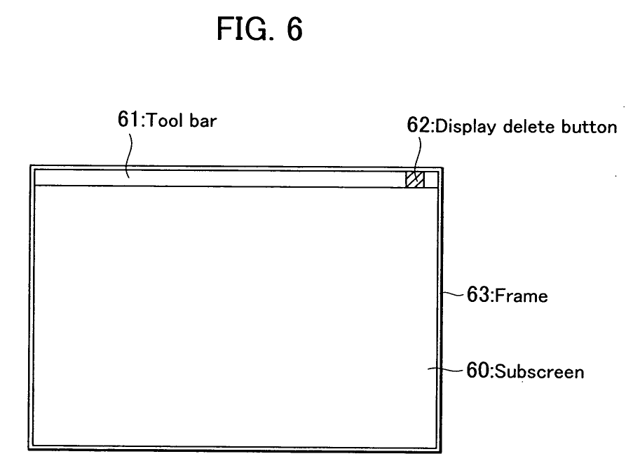

FIG. 6 is a schematic diagram of an example sub-screen on the monitor in a system employing the present invention.

FIG. 6 shows display delete button 62 on tool bar 61 on sub-screen 60. User interface controller 24 recognizes cursor operation on display delete button 62, controls image processor 22, and deletes sub-screen 60.

Displaying a sub-screen on a screen consisting of a main screen alone is made possible by launching software for sending a command to display a sub-screen on the main screen, which is a screen from the controllable computer. Upon activation, the command is sent as a communication signal to communication interface 23. User interface controller 24 analyzes the command and controls image processor 22 to display a sub-screen.

The size of sub-screen 60 can be changed by cursor operation on frame 63 of the sub-screen. User interface controller 24 recognizes cursor movement and controls image processor 22 to change the size of sub-screen 60 according to the cursor movement. The area of sub-screen 60 can also be moved by cursor operation on tool bar 61 on the sub-screen. User interface controller 24 recognizes cursor movement and controls image processor 22 to move the area of sub-screen 60 according to the cursor movement.

The present invention offers the following benefits:

Along with the screen from the computer controlled by user interfaces, those of uncontrolled computers connected thereto can be simultaneously displayed on one monitor. Since tasks being performed by each computer can be seen, work efficiency can be improved.

Switching between computers connected to user interfaces can be performed on an integrated screen by simply moving a cursor to the area of the screen from a computer to be switched to.

What is claimed is:

1. A computer switching device for switching between a plurality of computers for the operation using common user interfaces, comprising:
an input device switcher for performing switching to a computer to be controlled by input user interfaces;
an image processor for processing images from each computer;
a communication interface for performing data communications with computers; and
a user interface controller for controlling said input device switcher and said image processor based on information from said communication interface.

2. The computer switching device in accordance with claim 1, wherein said image processor integrates images from computers.

3. The computer switching device in accordance with claim 1 or 2, wherein said image processor produces an image from one computer as a main screen, whereon a minimized image from another computer is displayed as a sub-screen.

4. The computer switching device in accordance with claim 1 or 2, wherein said input device switcher selects a controllable computer according to information on a mouse-controlled cursor location on an integrated screen.

5. The computer switching device in accordance with claim 1 or 2, wherein said user interface is comprised of at least one of the following three types of user interface: a keyboard, a mouse, or a monitor.
